(19) United States
(12) Patent Application Publication
(10) Pub. No.: US 2005/0169454 A1
(43) Pub. Date: Aug. 4, 2005

(54) Distributed dialing system and method

(76) Inventor: Ryan N. Gregerson, Cedar City, UT (US)

Correspondence Address: Kory D. Christensen;STOEL RIVES LLP, One Utah Center, 201 South Main Street, Suite 1100, Salt Lake City, UT, 84111, US

(21) Appl. No.: 10/770,728

(22) Filed: Feb. 2, 2004

(51) Int. Cl. H04M 3/00; H04M 5/00; H04M 3/42

(52) U.S. Cl. 379/265.09; 379/210.02

(57) ABSTRACT

A distributed dialing system comprises a plurality of networked personal computers connected to a public switched telephone network (PSTN) through a gateway. Each personal computer includes an auto-dialing module to retrieve a different set of telephone numbers from a contact source and simultaneously dial at least a subset of the retrieved telephone numbers using the gateway. A communication module establishes a voice connection with a first contacted party in response to the gateway indicating that the first contacted party has answered. A routing module selects one of the networked personal computers that does not currently have an active voice connection in response to receiving an indication from the gateway that a second contacted party has answered while the voice connection with the first contacted party is still active. Thereafter, the routing module signals the selected personal computer to establish a voice connection with the second contacted party.

### TECHNICAL FIELD

The present invention relates generally to call centers. More specifically, the present invention relates to techniques for optimizing call centers to reduce, among other things, downtime and dropped calls.

### BACKGROUND OF THE INVENTION

Call centers are used extensively today in the fields of telemarketing, debt collection, and the like. In general, call centers rely on predictive dialers, which centrally dial telephone numbers for a group of call center agents. Only successfully connected calls are routed to the call center agents. Telephone numbers that are disconnected, busy, not answered, or invalid in other ways are screened out and documented.

Unfortunately, conventional predictive dialers suffer from at least four problems that are referred to herein as the “dirty” D's—downtime, “dough” (cost), drop, and delay. The first two problems arise from the basic architecture of predictive dialers, which are typically monolithic, hardware-based, and proprietary. If anything goes wrong with a predictive dialer, an entire call center may be crippled, resulting in significant and costly downtime. Furthermore, because predictive dialers often use proprietary hardware, the cost of setting up a new call center can be extremely high. For example, a typical predictive dialer for a small call center may cost $200,000 or more.

A drop occurs when a person answers a call but none of the call center agents are able to respond. To keep call center agents busy, predictive dialers place many more calls than there are agents with the hope that enough agents will be available on average to respond to answered calls. When too many people answer, calls are dropped. Drops are more than simply annoying to the public. Federal regulations have set strict limits on drops, and companies that exceed those limits may be fined.

A delay occurs between the time that a predictive dialer connects an answered call with one of the call center agents and the agent responds. Sometimes, delays are caused by the call center agent being unable to keep up with the pace of the predictive dialer. In other cases, an agent may have difficulty pronouncing a contacted party's name, leading to a delayed greeting. In either situation, a delay is often a signal to a contacted party that the call is from a debt collector or the like, which may cause the party to hang up.

No conventional predictive dialer has been successful in eliminating the four “dirty” D's, i.e., downtime, dough (cost), drop, and delay. Accordingly, no conventional predictive dialer provides a comprehensive solution to the problems that have plagued telephone call centers since their inception.

### BRIEF DESCRIPTION OF THE DRAWINGS

FIG. 1 is a block diagram of a typical call center as used in such applications as telemarketing and debt collection;

FIG. 2 is a block diagram of a distributed call center according to an embodiment of the invention;

FIG. 3 is a block diagram of a distributed dialer polling two other distributed dialers for status information;

FIG. 4 is a block diagram of a distributed dialer using a status table for routing a call;

FIG. 5 is an illustration of a technique for addressing a problem with delayed responses by call center agents;

FIG. 6 is a data flow diagram of a process for providing telephone numbers to a contact database and one or more distributed dialers;

FIG. 7 is a block diagram of functional components or modules of a distributed dialer; and

FIG. 8 is a flowchart of a method performed by a plurality of networked personal computers within a distributed call center.

### DETAILED DESCRIPTION

Reference is now made to the figures in which like reference numerals refer to like elements. For clarity, the first digit of a reference numeral indicates the figure number in which the corresponding element is first used.

In the following description, numerous specific details of programming, software modules, user selections, network transactions, database queries, database structures, etc., are provided for a thorough understanding of the embodiments of the invention. However, those skilled in the art will recognize that the invention can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

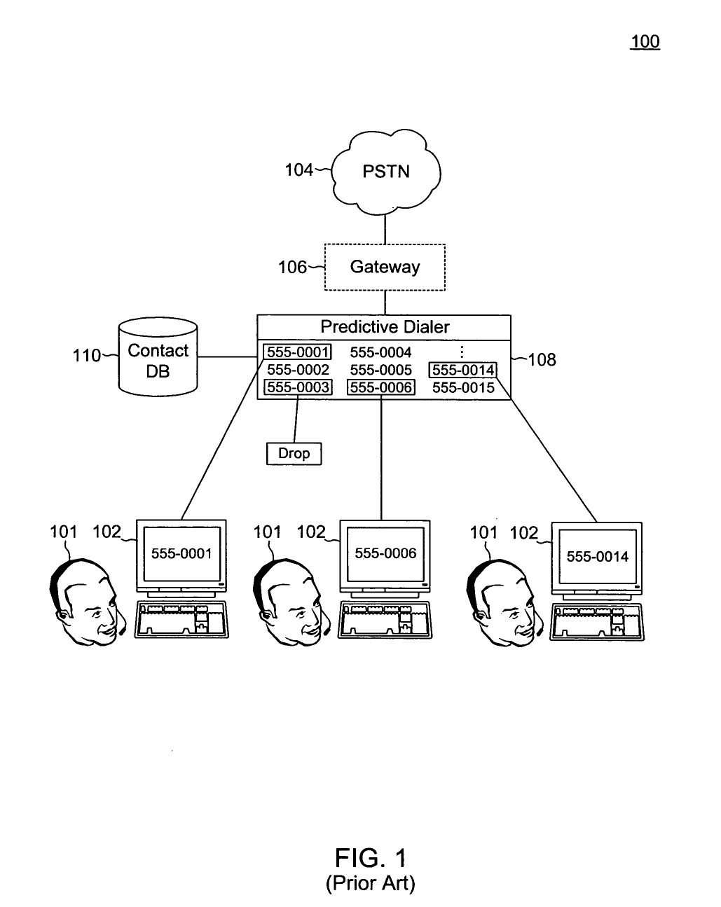

FIG. 1 is a block diagram of a typical call center 100, which may be used in a wide variety of applications, including debt collection, telemarketing, and the like. Call center agents 101 may use specially-equipped personal computers 102 to place telephone calls over a public switched telephone network (PSTN) 104. The personal computers 102 may access the PSTN 104 through a gateway 106 (or a predictive dialer 108 that provides gateway-like functions), which bridges the gap between digital computers and telephony. The personal computers 102 may use Voice over IP (VoIP) or other standard protocols to communicate with the gateway 106 or predictive dialer 108, which converts digital computer signals into analog telephone signals suitable for transmission over the PSTN 104.

Typically, a call center 100 uses the predictive dialer 108 to centrally dial telephone numbers for a group of call center agents 101. The predictive dialer 108 may retrieve the telephone numbers from a contact database (DB) 110 or generate the numbers sequentially for a particular area code or prefix. The predictive dialer 108 then places a large number of calls at the same time (e.g., fifteen telephone numbers in FIG. 1), depending on the number of call center agents 101.

Only successfully connected calls are routed to the call center agents 101. Telephone numbers that are disconnected, busy, not answered, or invalid in other ways are screened out and documented. When a call is not answered, the predictive dialer 108 usually reschedules the call for a later time.

Unfortunately, conventional predictive dialers 108 have several disadvantages aside from their high cost. For example, because all of the personal computers 102 rely on the same predictive dialer 108, a hardware or software failure in the predictive dialer 108 may cripple the entire call center 100.

In addition, all of the call center agents 101 may be busy when a call to a particular telephone number (e.g., 555-0003) is answered. This results in a drop. Federal regulations set strict limits on the percentage of allowable drops, and companies that exceed those limits may be fined.

Even if a call is not dropped, a call center agent 101 may delay for various reasons in responding to a person who answers a call. This delay may indicate to the recipient that the call is sales or debt related, which may prompt the recipient to hang up or at the very least put the call center agent 101 at a disadvantage once he or she finally responds.

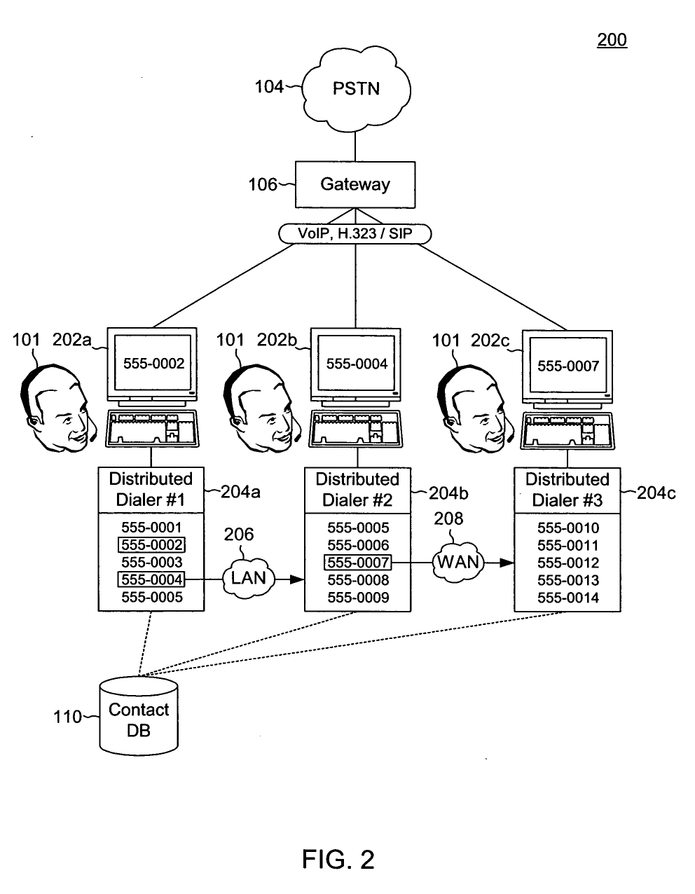

As illustrated in FIG. 2, the present invention solves the foregoing problems and disadvantages by providing a distributed call center 200 that can be inexpensively deployed and maintained for any number of call center agents 101. Like the call center 100 of FIG. 1, a distributed call center 200 includes a plurality of inexpensive personal computers 202 that communicate with a PSTN 104 through a gateway 106 using standard protocols, such as VoIP and H.323/SIP. However, the distributed call center 200 does not include a central predictive dialer 108. Rather, each personal computer 202 in the distributed call center 200 includes a distributed dialer 204, which may be embodied as a software program or a suitable combination of hardware and software.

The personal computers 202 may communicate with the gateway 106 and each other through a packet-switched network, such as a local area network (LAN) 206 and/or wide area network (WAN) 208. Some distributed call centers 200 may be “virtual,” meaning that none of the personal computers 202 are located within the same facility. This significantly reduces the cost of deploying a call center 200, since it allows call center agents 101 to work out of their own homes.

The distributed dialers 204 individually access the same contact database 110 (or one of a plurality of contact databases 110) to retrieve different sets of telephone numbers to be dialed. To avoid duplicate calls, the contact database 110 may include a field to indicate whether a particular telephone number has already been retrieved by one of the distributed dialers 204. The contact database(s) 110 may be accessed through the LAN 206 or WAN 208 and need not be located near the personal computers 202.

In operation, a distributed dialer 204 uses the gateway 106 to simultaneously dial several telephone numbers. The number of simultaneous calls may be based in part upon the number of call center agents 101 within the distributed call center 200. For instance, in the depicted embodiment, each of the distributed dialers 204 may simultaneously dial five telephone numbers.

When the gateway 106 indicates that one of the calls has been answered (as indicated by a box around the telephone number), and if the call center agent 101 associated with the distributed dialer 204 is not busy, the personal computer 202 establishes a voice connection with the answering party.

In some cases, however, the call center agent 101 may be busy with another call, be on break, etc. Accordingly, the distributed dialer 204 transfers the call to one of the other personal computers 202 in the call center 200 that is available to take the call. In one configuration, the transferring distributed dialer 204 automatically selects one of the personal computers 202 in the distributed call center 200 that is not busy using polling, status monitoring, or other techniques, as explained in greater detail below. The transferring dialer 204 then signals the selected personal computer 202 through the LAN 206 or WAN 208 to establish a voice connection with the answering party. The precise way in which the signaling is accomplished, or whether it is formulated as a request or a directive, is not crucial to the invention.

Since all of the personal computers 202 access the gateway 106 through a packet-switched network, seamless transfers may occur between any of the personal computers 202, even those in different cities, states, or countries. As noted, this may facilitate a “virtual” call center 200.

Once a distributed dialer 204 has called all of the retrieved telephone numbers, it may retrieve additional telephone numbers from the contact database 110. However, in one embodiment, a distributed dialer 204 for a personal computer 202 may suspend calling additional telephone numbers while a voice connection for that personal computer 202 is active. Calls that have already been placed through the gateway 106 may continue to progress. However, new calls may be halted until the voice connection has been terminated. This reduces the likelihood of drops. For instance, when all of the call center agents 101 are busy with calls, the distributed dialers 204 may stop dialing altogether, since no call center agents 101 are available to respond to answered calls.

As an example of the foregoing process, suppose that a first distributed dialer 204a calls five telephone numbers at the same time, e.g., 555-0001 through 555-0005. When the gateway 106 indicates that a first telephone number has been answered, e.g., 555-0002, the personal computer 202a hosting the first distributed dialer 204a establishes a voice connection with the answering party.

However, suppose that the gateway 106 indicates that a second telephone number, e.g., 555-0004, called by the distributed dialer 204a has been answered by a second party while the personal computer 202a is still connected to the first party. In such a case, the distributed dialer 204a identifies another personal computer 202b within the call center 200 that is not busy and signals that personal computer 202b through the LAN 208 to establish a voice connection with the second party.

Similarly, after the second personal computer 202b has established a voice connection with the second party, the gateway 106 may indicate that a call (e.g., 555-0007) placed by the second distributed dialer 204b has been answered. Accordingly, the second distributed dialer 204b transfers the call through the WAN 208 to a personal computer 202c that is not busy.

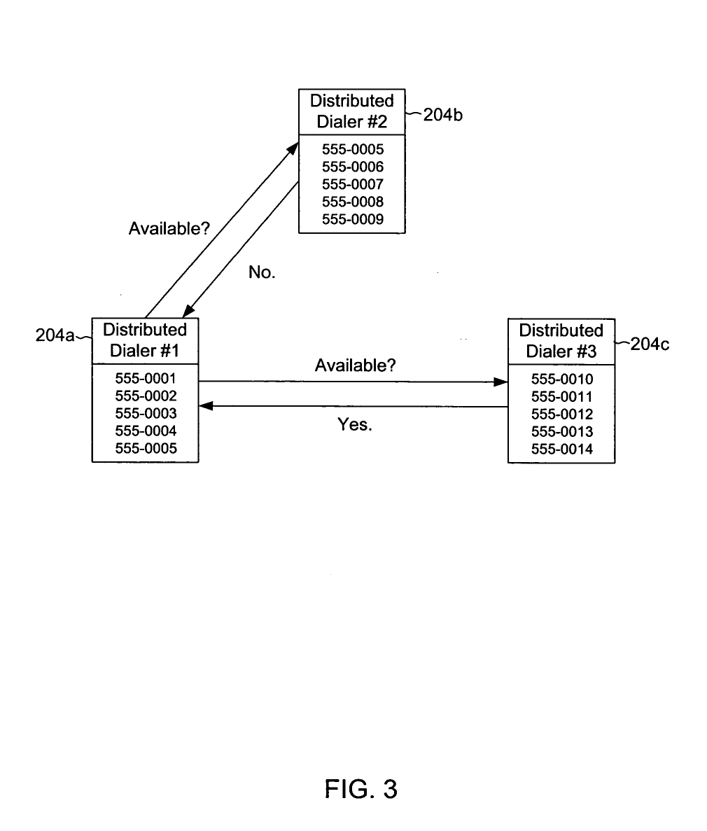

As previously noted, a distributed dialer 204 may use various techniques for determining which personal computer 202 should receive a transferred call. For example, as shown in FIG. 3, a first distributed dialer 204a may poll the other distributed dialers 204b-c in sequence or randomly until one of the distributed dialers 204c responds affirmatively.

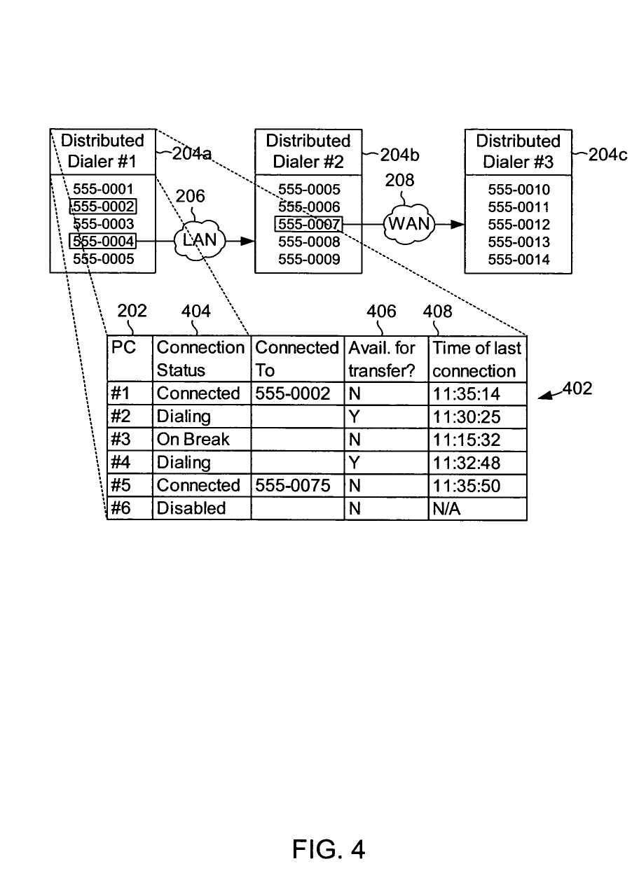

Alternatively, as shown in FIG. 4, each distributed dialer 204 may actively monitor the personal computers 202 in the call center 200 to generate and maintain a status table 402 or similar data structure. For instance, the status table 402 may include a status indication 404 for each personal computer 202, e.g., Connected, Dialing, On Break, Disabled, etc. In the example embodiment, the status table 402 may include a specific indication 406 of whether the personal computer 202 is available to receive a transferred call, although this information could be determined from the status indication 404 in other embodiments.

Each distributed dialer 204 may maintain its status table 402 by periodically requesting information from similar tables 402 maintained by the other distributed dialers 204. Alternatively, each distributed dialer 204 may be responsible for informing the other distributed dialers 204 in the event of a change in status.

In one embodiment, the status table 402 may include an indication 408 of the time that the associated personal computer 202 was last connected. This allows the distributed dialer 204 to implement a least recently used (LRU) algorithm which fairly transfers calls to the personal computer 202 that has been waiting the longest for a connection. Those of skill in the art will recognize that a variety of other load balancing techniques may be used within the scope of the invention.

As previously noted, one of the difficulties with conventional systems is the delay between the moment that a call is answered and the time that a call center agent 101 responds. Although the delay may only last for a few seconds, it may be sufficient to cause the answering party to hang up.

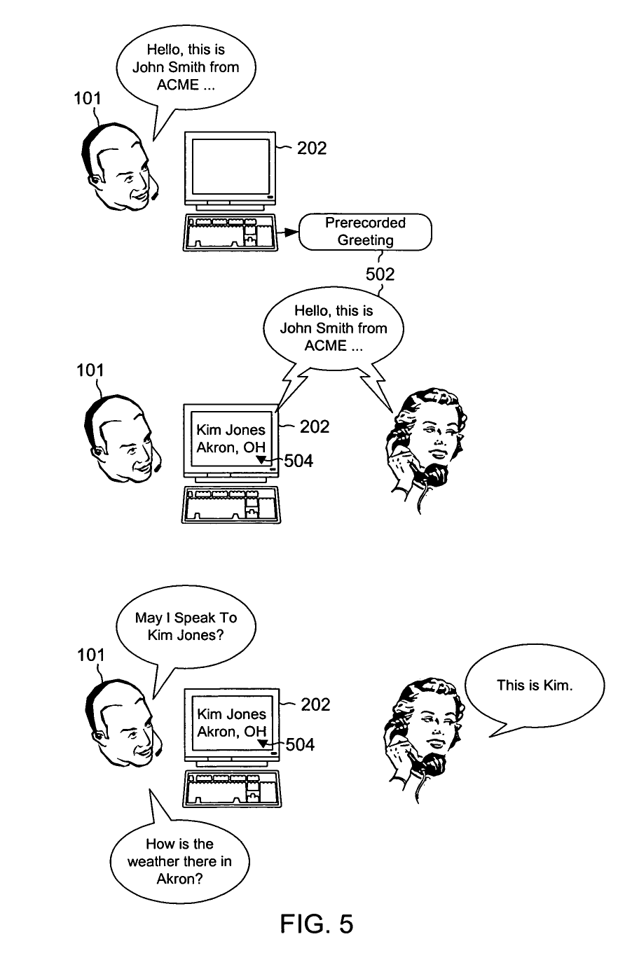

This problem is solved, as shown in FIG. 5, by having the call center agent 101 prerecord a greeting 502, e.g., “Hello, this is John Smith from ACME.” When the contacted party answers, the personal computer 202 immediately plays the prerecorded greeting 502 to the contacted party to simulate the telephonic presence of the call center agent 101 and compensate for any delay in responding.

In addition to notifying the call center agent 101 that the call has been answered, the personal computer 202 may simultaneously play the prerecorded greeting 502 to the call center agent 101 so that he or she will know when to begin speaking to make a seamless transition to speaking with the contacted party. Because the prerecorded greeting 502 was made by the call center agent 101, the contacted party may not even be aware that the initial greeting 502 was not live. This gives the call center agent 101 time to transition from call to call, as well as to determine how to pronounce tricky names.

Furthermore, the prerecorded greeting also provides the call center agent 101 with time to learn additional information 504 about the contacted party. For example, the additional information 504 may include the city and state of the contacted party, details about previous attempts to reach the contacted party (in the case of debt collection), etc.

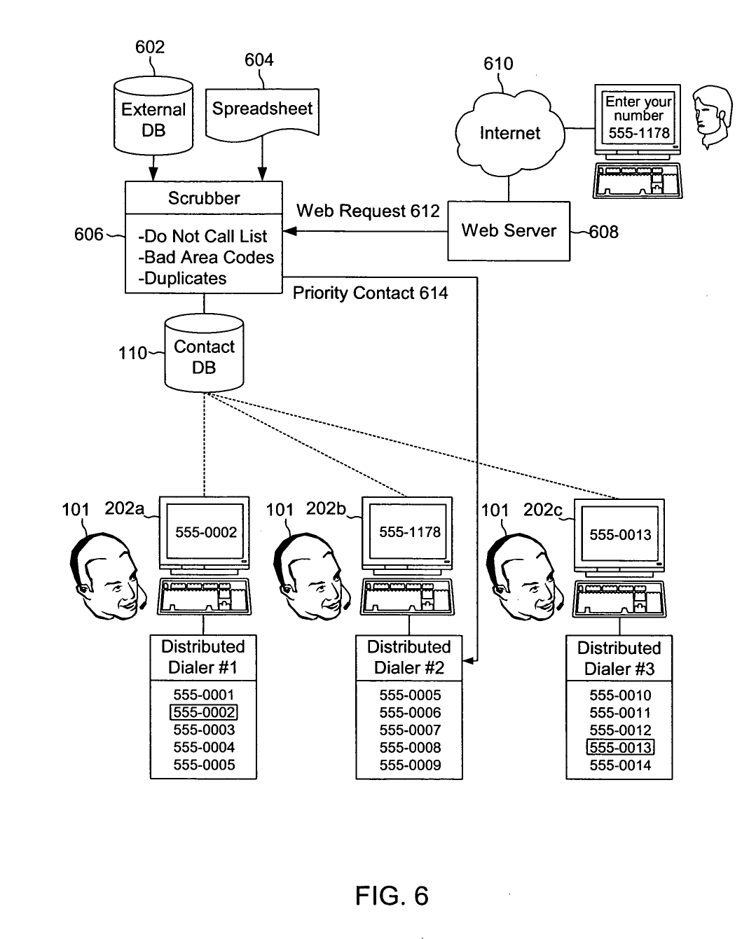

FIG. 6 illustrates additional details of how telephone numbers are entered into the contact database 110 and provided to the distributed dialers 204. Telephone numbers may originate from various sources, such as external databases 602, spreadsheets 604, or the like. A scrubber 606 may scrub (remove) telephone numbers listed in the national Do Not Call List (DNCL), telephone numbers with bad area codes, and/or duplicate telephone numbers.

In certain embodiments, a user may self-refer his or her telephone number to a distributed call center 200. For instance, a user may access a web server 608 via the Internet 610 in response to an advertisement on an affiliated website. A web request 612 including the telephone number is sent to the scrubber 606, which ensures, for example, that the provided telephone number has a good area code.

A priority contact 614 is then immediately sent to one of the distributed dialers 204, preferably one that is associated with a personal computer 202 that is not already busy with another party. This may be determined, for example, with reference to the status tables 402 for the distributed dialers 204. In various embodiments, the “time of last connection” indicator 408 may be used to prioritize between two or more personal computers 202 that are available. Alternatively, the priority contact 614 may be sent at random to one of the distributed dialers 204, which may transfer it to one of the other dialers 204 if necessary.

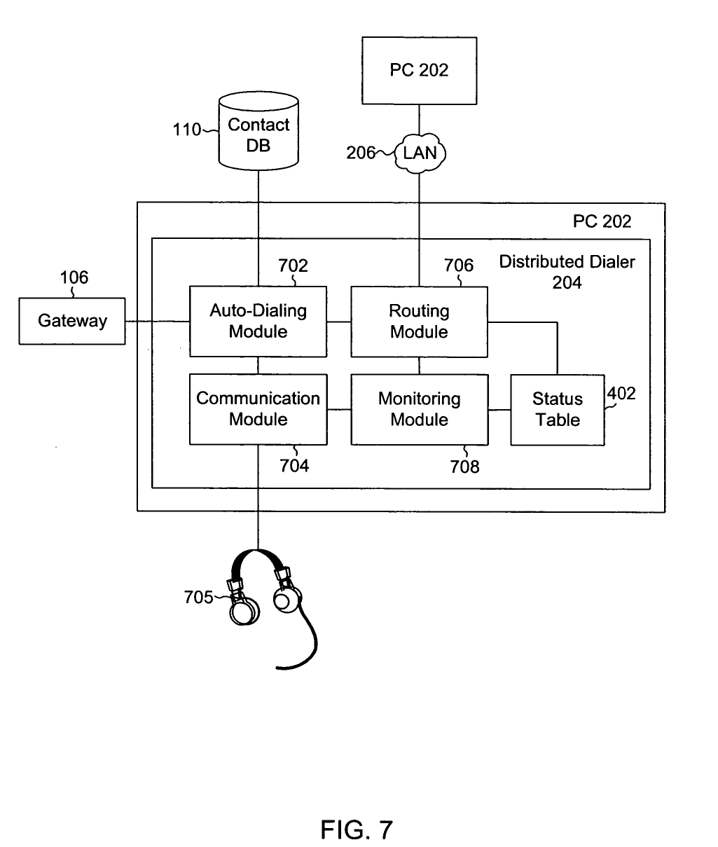

FIG. 7 shows additional details of a distributed dialer 204 for a personal computer 202 in a distributed call center 200. In one embodiment, the distributed dialer 204 comprises a plurality of functional components or modules, each of which may be implemented using software or any suitable combination of software and hardware. Various modules may be combined in one embodiment, while the functionality of one module may be performed by two or more modules in a different embodiment.

As illustrated, the distributed dialer 204 may include an auto-dialing module 702, which receives a set of telephone numbers from the contact database 110 and uses the gateway 106 to automatically dial several of the numbers simultaneously. A communication module 704 establishes a voice communication with a contacted party when the gateway 106 indicates that the party has answered. As illustrated, the communication module 704 may be coupled to a standard telephone headset 705, which allows a call center agent 101 (not shown) to communicate with the contacted party once the voice connection has been established.

A routing module 706 is used when the gateway 106 indicates that a call has been answered but the communication module 704 already has an active voice connection. In one embodiment, the routing module 706 accesses a status table 402 indicating which other personal computers 202 (accessible via the LAN 206) are currently able to accept a transferred call. The routing module 706 then transfers the call to one of those personal computers 202, as previously described.

A monitoring module 708 maintains the status table 402 in one implementation by accessing similar status tables 402 maintained by distributed dialers 204 in different networked PCs 202. Alternatively, the monitoring module 708 may receive periodic status updates from the other distributed dialers 204.

Although not illustrated, those of skill in the art will recognize that the personal computer 202 may include various standard components known to those of skill in the art, such as a CPU, memory, video card, sound card, network interface, one or more I/O interfaces, and the like.

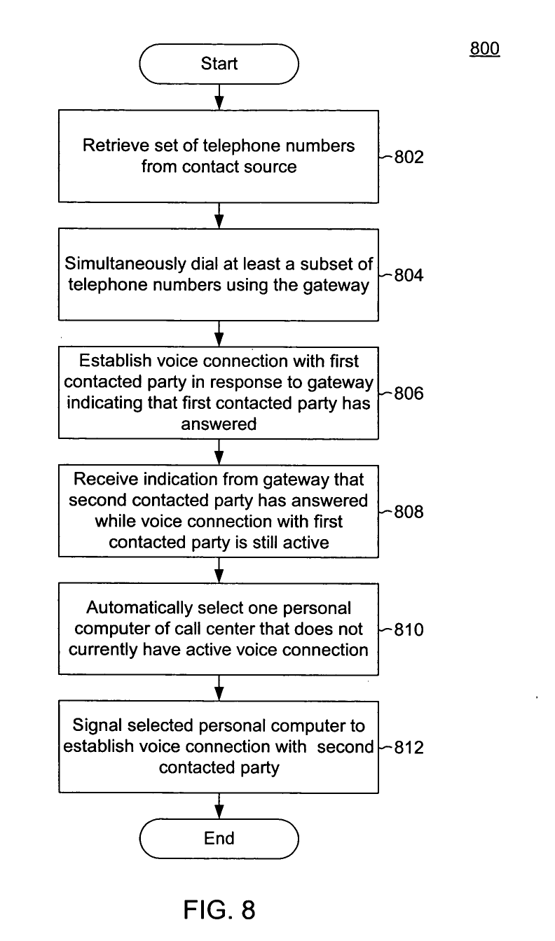

FIG. 8 is a flowchart of a method 800 performed by a plurality of networked personal computers 202 within a distributed call center 200. A personal computer 202 initially retrieves 802 a set of telephone numbers from a contact source, such as a contact database 110 or the like. Thereafter, the personal computer 202 simultaneously dials 804 at least a subset of the telephone numbers using a gateway 106, which bridges the gap between digital computers and telephony.

In response to the gateway 106 indicating that a first contacted party has answered, the personal computer 202 establishes 806 a voice connection with the first contacted party.

If, while the voice connection is still active, the personal computer 202 receives 808 an indication from the gateway 106 that a second contacted party has answered, the personal computer 202 automatically selects 810 one of the networked personal computers 202 of the distributed call center 200 that does not currently have an active voice connection. The personal computer 202 then signals 812 the selected personal computer to establish a voice connection with the second contacted party, after which the method 800 is complete.

In view of the foregoing, the present invention offers several advantages not found in conventional approaches. Initially, by distributing the dialing function among a plurality of inexpensive personal computers, a distributed call center will not suffer the downtime of a standard call center if its predictive dialer becomes disabled. Likewise, the cost of the distributed call center is further reduced because the dialing function may be implemented in software.

Because each of the distributed dialers stop dialing additional telephone numbers once a voice connection is established with the hosting personal computer, the likelihood of a drop is reduced. By contrast, standard call centers are slow to react to changing call load and will often result in a number of drops that exceed Federal mandates.

Finally, by pre-recording a greeting for a call center agent and playing that greeting immediately upon connection, the problem with delay is ameliorated. Call center agents are given substantially more time to transition from call to call, learn to pronounce tricky names, find out additional information concerning the contacted party, etc.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention.

1. A method for distributing a dialing function of a call center among a plurality of networked personal computers connected to a public switched telephone network (PSTN) through a gateway, the method comprising:
within each personal computer:
retrieving a different set of telephone numbers from a contact source;
simultaneously dialing at least a subset of the telephone numbers using the gateway;
establishing a voice connection with a first contacted party in response to the gateway indicating that the first contacted party has answered;
receiving an indication from the gateway that a second contacted party has answered while the voice connection with the first contacted party is still active;
automatically selecting one of the networked personal computers that does not currently have an active voice connection; and
signaling the selected personal computer to establish a voice connection with the second contacted party.

2. The method of claim 1, further comprising suspending the dialing of additional telephone numbers for a personal computer with an active voice connection.

3. The method of claim 1, wherein establishing a voice connection comprises:
notifying a call center agent using the personal computer that the call has been answered by the first contacted party; and
immediately playing to the first contacted party a greeting previously recorded by the call center agent to compensate for any delay by the call center agent in responding to the first contacted party's answer.

4. The method of claim 3, wherein notifying further comprises providing the call center agent with details about the first contacted party during playback of the prerecorded greeting.

5. The method of claim 4, wherein the details are selected from the group consisting of city of residence, state of residence, local time, and information about previous attempts to reach the first contacted party.

6. The method of claim 3, wherein establishing further comprises simultaneously playing the prerecorded greeting to the call center agent to allow the call center agent to make a seamless transition to speaking with the first contacted party.

7. The method of claim 1, wherein the contact source comprises a common database for all of the personal computers in the call center, and wherein the database includes a field to indicate whether a particular telephone number has been previously retrieved by a different personal computer to prevent duplicate retrievals.

8. The method of claim 7, further comprising scrubbing the contact database for telephone numbers on a do-not-call list, duplicate telephone numbers, and telephone numbers with invalid area codes.

9. The method of claim 1, wherein the contact source comprises an affiliated website, the method further comprising receiving a real-time request from the affiliated website comprising the first contacted party's telephone number.

10. The method of claim 1, further comprising monitoring a voice connection status of each networked personal computer in the call center.

11. A method for deploying a call center using a plurality of inexpensive personal computers, the method comprising:
coupling the plurality of personal computers to a public switched telephone network (PSTN) through a gateway;
networking the plurality of personal computers to permit each personal computer to monitor a voice connection status of the other personal computers in the call center;
connecting the plurality of personal computers to a contact source such that each personal computer may retrieve a different set of telephone numbers to dial;
installing an auto-dialer on each of the personal computers for simultaneously dialing at least a subset of the retrieved set of telephone numbers for the personal computer using the gateway;
furnishing each personal computer with communication software to establish a voice connection with a first contacted party in response to the gateway indicating that the first contacted party has answered;
providing each personal computer with routing software to automatically transfer a call to a second party answered while the voice connection with the first contacted party is still active to one of the other personal computers that does not currently have an active voice connection.

12. The method of claim 11, further comprising configuring the auto-dialer of each personal computer to suspend the dialing of additional telephone numbers while the voice connection with the first contacted party remains active.

13. The method of claim 11, further comprising adapting the communication software to immediately play to the first contacted party a greeting previously recorded by the call center agent to compensate for any delay by the call center agent in responding to the first contacted party's answer.

14. The method of claim 13, further comprising adapting the communication software to provide the call center agent with details about the first contacted party during playback of the prerecorded greeting.

15. The method of claim 14, wherein the details are selected from the group consisting of city of residence, state of residence, local time, and information about previous attempts to reach the first contacted party.

16. The method of claim 13, further comprising adapting the communication software to simultaneously play the prerecorded greeting to the call center agent to allow the call center agent to make a seamless transition to speaking with the first contacted party.

17. The method of claim 11, wherein the contact source comprises a common database for all of the personal computers in the call center, and wherein the database includes a field to indicate whether a particular telephone number has been previously retrieved by a different personal computer to prevent duplicate retrievals.

18. The method of claim 17, further comprising providing a scrubber to scrub the contact database for telephone numbers on a do-not-call list, duplicate telephone numbers, and telephone numbers with invalid area codes.

19. The method of claim 11, wherein the contact source comprises an affiliated website, the method further comprising coupling each auto-dialer to receive a real-time request from the affiliated website comprising the first contacted party's telephone number.

20. A method for distributing a dialing function of a call center among a plurality of networked personal computers connected to a public switched telephone network (PSTN) through a gateway, the method comprising:
within each personal computer:
retrieving a different set of telephone numbers from a contact source;
simultaneously calling at least a subset of the telephone numbers using the gateway;
in response to the gateway indicating that the first contacted party has answered a call to a first telephone number:
establishing a voice connection with a first contacted party; and
in response to receiving an indication from the gateway that a second contacted party has answered a call to a second telephone while the voice connection with the first contacted party is still active:
automatically routing the call to the second contacted party to a selected one of the networked personal computers that does not currently have an active voice connection.

21. A distributed dialing system comprising a plurality of networked personal computers connected to a public switched telephone network (PSTN) through a gateway, each personal computer comprising:
an auto-dialing module to retrieve a different set of telephone numbers from a contact source and simultaneously dial at least a subset of the retrieved telephone numbers using the gateway;
a communication module to establish a voice connection with a first contacted party in response to the gateway indicating that the first contacted party has answered; and
a routing module to select one of the networked personal computers that does not currently have an active voice connection in response to receiving an indication from the gateway that a second contacted party has answered while the voice connection with the first contacted party is still active, and to signal the selected personal computer to establish a voice connection with the second contacted party.

22. The system of claim 21, wherein the auto-dialing module is to suspend the dialing of additional telephone numbers within the personal computer while the voice connection with the first contacted party remains active.

23. The system of claim 21, wherein the communication module, in response to establishing a voice connection, is to notify a call center agent using the personal computer that the call has been answered by the first contacted party and immediately play to the first contacted party a greeting previously recorded by the call center agent to compensate for any delay by the call center agent in responding to the first contacted party's answer.

24. The system of claim 23, wherein the communication module is to provide the call center agent with details about the first contacted party during playback of the prerecorded greeting.

25. The system of claim 24, wherein the details are selected from the group consisting of city of residence, state of residence, local time, and information about previous attempts to reach the first contacted party.

26. The system of claim 23, wherein the communication module is to simultaneously play the prerecorded greeting to the call center agent to allow the call center agent to make a seamless transition to speaking with the first contacted party.

27. The system of claim 21, wherein the contact source comprises a common database for all of the personal computers in the call center, and wherein the database includes a field to indicate whether a particular telephone number has been previously retrieved by a different personal computer to prevent duplicate retrievals.

28. The system of claim 27, further comprising a scrubbing module to scrub the contact database for telephone numbers on a do-not-call list, duplicate telephone numbers, and telephone numbers with invalid area codes.

29. The system of claim 21, wherein the contact source comprises an affiliated website, and wherein the auto-dialing module is to receive a real-time request from the affiliated website comprising the first contacted party's telephone number.

30. The system of claim 21, further comprising a monitoring module to monitor a voice connection status of each networked personal computer in the call center.

31. A computer program product for performing a method for distributing a dialing function of a call center among a plurality of networked personal computers connected to a public switched telephone network (PSTN) through a gateway, the computer program product comprising:
program code within each personal computer to:
retrieve a different set of telephone numbers from a contact source;
simultaneously dial at least a subset of the telephone numbers using the gateway;
establish a voice connection with a first contacted party in response to the gateway indicating that the first contacted party has answered;
receive an indication from the gateway that a second contacted party has answered while the voice connection with the first contacted party is still active;
automatically select one of the networked personal computers that does not currently have an active voice connection; and
signal the selected personal computer to establish a voice connection with the second contacted party.

32. The computer program product of claim 31, further comprising program code for suspending the dialing of additional telephone numbers for a personal computer with an active voice connection.

33. The computer program product of claim 31, further comprising:
program code for notifying a call center agent using the personal computer that the call has been answered by the first contacted party; and
program code for immediately playing to the first contacted party a greeting previously recorded by the call center agent to compensate for any delay by the call center agent in responding to the first contacted party's answer.

34. The computer program product of claim 33, further comprising program code for providing the call center agent with details about the first contacted party during playback of the prerecorded greeting.

35. The computer program product of claim 34, wherein the details are selected from the group consisting of city of residence, state of residence, local time, and information about previous attempts to reach the first contacted party.

36. The computer program product of claim 33, further comprising program code for simultaneously playing the prerecorded greeting to the call center agent to allow the call center agent to make a seamless transition to speaking with the first contacted party.

37. The computer program product of claim 31, wherein the contact source comprises a common database for all of the personal computers in the call center, and wherein the database includes a field to indicate whether a particular telephone number has been previously retrieved by a different personal computer to prevent duplicate retrievals.

38. The computer program product of claim 37, further comprising program code for scrubbing the contact database for telephone numbers on a do-not-call list, duplicate telephone numbers, and telephone numbers with invalid area codes.

39. The computer program product of claim 31, further comprising program code for receiving a real-time request from an affiliated website comprising the first contacted party's telephone number.

40. The computer program product of claim 31, further comprising program code for monitoring a voice connection status of each networked personal computer in the call center.

41. A virtual call center comprising:
a plurality of remotely-located personal computers connected to a public switched telephone network (PSTN) through a gateway, each personal computer comprising:
a network interface for communicating with the other personal computers through a wide area network;
an auto-dialer to retrieve a different set of telephone numbers from a database and simultaneously dial at least a subset of the retrieved telephone numbers using the gateway;
a communication module to establish a voice connection with a first contacted party in response to the gateway indicating that the first contacted party has answered; and
a routing module to automatically transfer a call to a second party answered while the voice connection with the first contacted party is still active to one of the other personal computers of the virtual call center that does not currently have an active voice connection.

42. A distributed dialing apparatus comprising:
dialing means for retrieving a different set of telephone numbers from a contact source and simultaneously dial at least a subset of the retrieved telephone numbers using a gateway;
communication means for establishing a voice connection with a first contacted party in response to the gateway indicating that the first contacted party has answered; and
transfer means for passing a call answered by a second contacted party, while the voice connection with the first contacted party is still active, to a selected one of the networked personal computers that does not currently have an active voice connection.
